(19) United States
(12) Patent Application Publication
(10) Pub. No.: US 2015/0252216 A1
(43) Pub. Date: Sep. 10, 2015

(54) PATTERN-FORMING METHOD AND DIRECTED SELF-ASSEMBLING COMPOSITION

(71) Applicant: JSR CORPORATION, Tokyo (JP)

(72) Inventors: Shinya MINEGISHI, Tokyo (JP); Takehiko NARUOKA, Tokyo (JP); Tomoki NAGAI, Tokyo (JP)

(73) Assignee: JSR CORPORATION, Tokyo (JP)

(21) Appl. No.: 14/638,844

(22) Filed: Mar. 4, 2015

(30) Foreign Application Priority Data
Mar. 6, 2014 (JP) 2014-044442

(51) Int. Cl. C09D 153/00

(52) U.S. Cl. CPC C09D 153/00

(57) ABSTRACT

A pattern-forming method includes providing a coating film using a composition that includes: a first polymer which is a block copolymer; and a second polymer having a surface free energy lower than a surface free energy of the first polymer, such that the second polymer is unevenly distributed to be localized into a superficial layer region of the coating film. Phase separation is caused in the coating film along a direction substantially perpendicular to a thickness direction of the coating film such that at least a part of the coating film is converted into a directed self-assembling film which includes a plurality of phases. A part of the plurality of phases of the directed self-assembling film is removed.

### CROSS-REFERENCE TO RELATED APPLICATIONS

The present application claims priority to Japanese Patent Application No. 2014-44442, filed Mar. 6, 2014. The contents of this application are incorporated herein by reference in their entirety.

### BACKGROUND OF THE INVENTION

1. Field of the Invention

The present invention relates to a pattern-forming method and a directed self-assembling composition.

2. Discussion of the Background

Miniaturization of various types of electronic device structures such as semiconductor devices and liquid crystal devices has been accompanied by demands for microfabrication of patterns in lithography processes. In these days, although fine patterns having a line width of about 50 nm can be formed using, for example, an ArF excimer laser beam, further finer pattern formation has been required.

To meet the demands described above, a pattern-forming method which utilizes a phase separation structure formed by the directed self-assembly, as generally referred to, that spontaneously forms an ordered pattern have been proposed. For example, an ultrafine pattern-forming method by directed self-assembly has been known in which a block copolymer obtained by copolymerizing a monomer compound having one property with a monomer compound having a property that is distinct from the one property is involved (see Japanese Unexamined Patent Application, Publication No. 2008-149447, Japanese Unexamined Patent Application (Translation of PCT Application), Publication No. 2002-519728 and Japanese Unexamined Patent Application, Publication No. 2003-218383). According to this method, annealing of a film formed from a composition containing the block copolymer results in a tendency of clustering of polymer structures having the same property, and thus a pattern can be formed in a self-aligning manner.

However, patterns obtained by utilizing the phase separation structure formed by such directed self-assembly are not deemed to be yet sufficiently fine, and additionally have drawbacks such as significant variations of a pattern size; therefore an improvement thereof has been demanded. As one of methods for achieving such an improvement, it is known that when a coating film of a directed self-assembling composition is provided on other film (hereinafter, may be also referred to as “underlayer film”), the abovementioned phase separation through the directed self-assembly may effectively occur, and materials and the like for the underlayer film have been investigated (see Japanese Unexamined Patent Application, Publication Nos. 2008-36491 and 2012-174984).

### SUMMARY OF THE INVENTION

According to one aspect of the present invention, a pattern-forming method includes providing a coating film using a composition that includes: a first polymer which is a block copolymer; and a second polymer having a surface free energy lower than a surface free energy of the first polymer, such that the second polymer is unevenly distributed to be localized into a superficial layer region of the coating film. Phase separation is caused in the coating film along a direction substantially perpendicular to a thickness direction of the coating film such that at least a part of the coating film is converted into a directed self-assembling film which includes a plurality of phases. A part of the plurality of phases of the directed self-assembling film is removed.

According to another aspect of the present invention, a directed self-assembling composition includes a block copolymer, and a polymer having a surface free energy lower than a surface free energy of the block copolymer.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 shows a schematic view illustrating one example of a state after providing an underlayer film on a substrate in the pattern-forming method according to an embodiment of the present invention;

FIG. 2 shows a schematic view illustrating one example of a state after forming a prepattern on the underlayer film in the pattern-forming method according to the embodiment of the present invention;

FIG. 3 shows a schematic view illustrating one example of a state after providing, on a region surrounded by the prepattern on the underlayer film, a coating film in which a second polymer is unevenly distributed to be localized into a superficial layer region in the pattern-forming method according to the embodiment of the present invention;

FIG. 4 shows a schematic view illustrating one example of a state after converting at least a part of the coating film into a directed self-assembling film by causing phase separation in the coating film along a substantially perpendicular direction in the pattern-forming method according to the embodiment of the present invention; and

FIG. 5 shows a schematic view illustrating one example of a state after removing a part of a plurality of phases of the directed self-assembling film, the superficial layer region and the prepattern in the pattern-forming method according to the embodiment of the present invention.

### DESCRIPTION OF THE EMBODIMENTS

According to an embodiment of the invention made for solving the aforementioned problems, a pattern-forming method includes:

providing a coating film using a composition that contains a first polymer which is a block copolymer (hereinafter, may be also referred to as “(A) block copolymer” or “block copolymer (A)”), and a second polymer having a lower surface free energy than that of the block copolymer (hereinafter, may be also referred to as “(B) polymer” or “polymer (B)”), such that the second polymer is unevenly distributed to be localized into a superficial layer region of the coating film;

converting at least a part of the coating film into a directed self-assembling film by causing phase separation in the coating film along a substantially perpendicular direction; and

removing a part of a plurality of phases of the directed self-assembling film.

According to another embodiment of the invention made for solving the aforementioned problems, a directed self-assembling composition contains: a block copolymer; and a polymer having a lower surface free energy than that of the block copolymer.

According to the pattern-forming method and the directed self-assembling composition of the embodiments of the present invention, a sufficiently fine pattern can be conveniently formed. Therefore, these can be suitably used for lithography processes in manufacture of various types of electronic devices such as semiconductor devices and liquid crystal devices for which further miniaturization is demanded. The embodiments of the present invention will now be described in detail.

### Pattern-Forming Method

A pattern-forming method according to an embodiment of the present invention includes:

providing a coating film using a composition that contains the block copolymer (A), and the polymer (B) (hereinafter, may be also referred to as “directed self-assembling composition (I)”), such that the polymer (B) is unevenly distributed to be localized into a superficial layer region of the coating film (hereinafter, may be also referred to as “coating film-providing step”);

converting at least a part of the coating film into a directed self-assembling film by causing phase separation in the coating film along a substantially perpendicular direction (hereinafter, may be also referred to as “directed self-assembling step”); and

removing a part of a plurality of phases of the directed self-assembling film (hereinafter, may be also referred to as “removing step”).

It is preferred that the pattern-forming method further includes providing an underlayer film on a substrate (hereinafter, may be also referred to as “underlayer film-providing step”) before the coating film-providing step, and that in the coating film-providing step, the coating film is provided on the underlayer film.

It is also preferred that the pattern-forming method further includes forming a prepattern (hereinafter, may be also referred to as “prepattern-forming step”) before the coating film-providing step, and that in the coating film-providing step, the coating film is provided in a region compartmentalized by the prepattern.

The terms “directed self assembly” and “directed self-assembling” as referred to means a phenomenon of spontaneously constructing a tissue or a structure without resulting from only the control from an external factor. In the embodiment of the present invention, a film having a phase separation structure formed by directed self-assembly (directed self-assembling film) is provided from the directed self-assembling composition (I), and a part of a plurality of phases of the directed self-assembling film is removed, whereby a pattern can be formed.

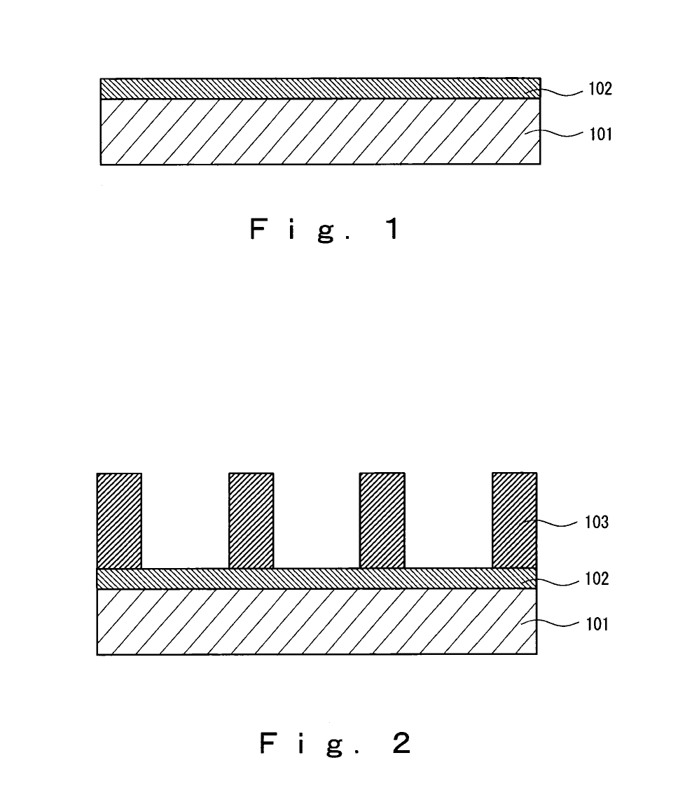

Hereinafter, each step will be explained with reference to FIGS. 1 to 5.

### Underlayer Film-Providing Step

In this step, an underlayer film is provided on a substrate. Thus, an underlayer film-bearing substrate in which an underlayer film 102 is provided on the substrate 101 can be obtained, as shown in FIG. 1, and the coating film 104 is provided on the underlayer film 102. The phase separation structure formed by the phase separation of at least a part of the coating film 104 (microdomain structure) is altered by not only an interaction between blocks of the block copolymer (A) contained in the directed self-assembling composition (I), but also an interaction with the underlayer film 102; therefore, the structure may be more easily controlled by virtue of having the underlayer film 102. Furthermore, when the coating film 104 is thin, a transfer process thereof can be improved owing to having the underlayer film 102.

As the substrate 101, for example, a conventionally well-known substrate, e.g., a silicon wafer, a wafer coated with aluminum or the like may be used.

Moreover, as a composition for forming an underlayer film for use in providing the underlayer film, a conventionally well-known material for forming an organic underlayer film, and the like may be used, and examples thereof include compositions for forming an underlayer film which contain a crosslinking agent, and the like.

Although the procedure for providing the underlayer film 102 is not particularly limited, an exemplary procedure may involve, for example, applying the composition for forming an underlayer film to the substrate 101 through a well-known method such as a spin coating method, followed by an exposure and/or heating to permit curing of the composition for forming an underlayer film, and the like. Examples of the radioactive ray which may be employed for the exposure include visible light rays, ultraviolet rays, far ultraviolet rays, X-rays, electron beams, γ-rays, molecular beams, ion beams, and the like. Moreover, the temperature employed in the heating is not particularly limited, and is preferably 90° C. to 550° C., more preferably 90° C. to 450° C., and still more preferably 90° C. to 300° C. The film thickness of the underlayer film 102 is not particularly limited, and is preferably 30 nm to 20,000 nm, more preferably 40 nm to 1,000 nm, and still more preferably 50 nm to 500 nm. In addition, the underlayer film 102 preferably includes an SOC (Spin on Carbon) film.

### Prepattern-Forming Step

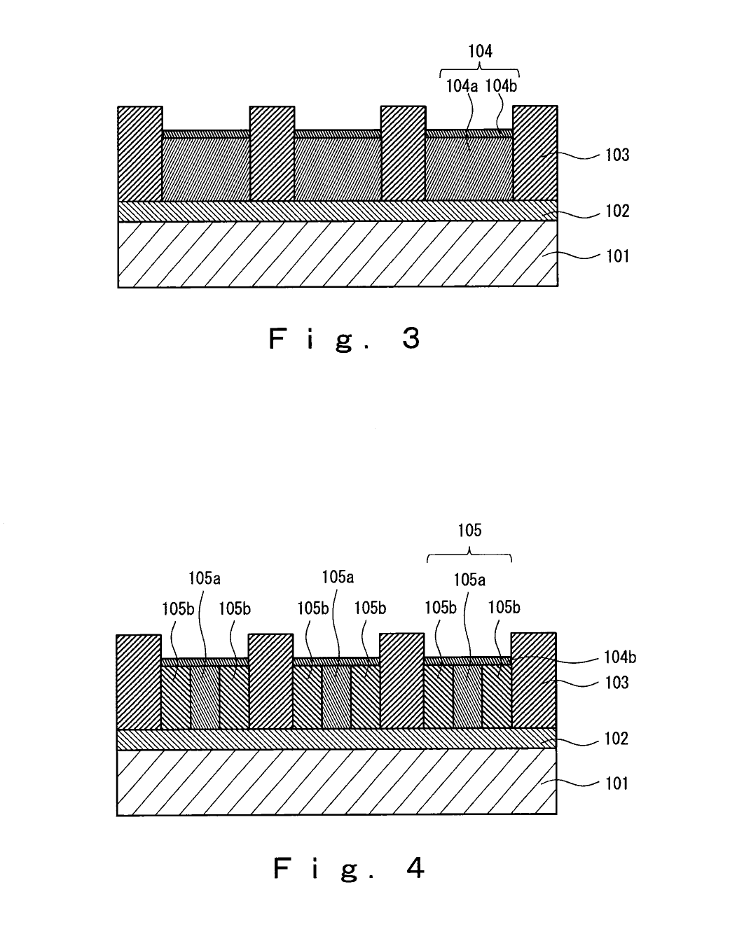

In this step, a prepattern is formed. This prepattern may be formed on the substrate, or may be formed on the underlayer film 101 provided in the underlayer film-providing step as shown in FIG. 2. The prepattern 103 enables a configuration of the phase separation structure formed by the directed self-assembly in the coating film 104 to be controlled, and thus a finer pattern can be formed. More specifically, among the blocks included in the block copolymer (A) contained in the directed self-assembling composition (I), a block having a higher affinity to a lateral face of the prepattern (hereinafter, may be also referred to as “block (I)”) forms phases 105b along the prepattern, whereas a block having a lower affinity (hereinafter, may be also referred to as “block (II)”) forms phases 105a at positions away from the prepattern. Thus, a finer and more favorable pattern can be formed. In addition, according to the material, size, shape, etc. of the prepattern, the structure of the pattern formed through phase separation of the directed self-assembling composition (I) can be more minutely controlled. It is to be noted that the prepattern 103 may be appropriately selected depending on the pattern intended to be finally formed, and, for example, a line-and-space pattern, a hole pattern or the like may be employed.

As the method for forming the prepattern 103, methods similar to well-known resist pattern-forming methods, and the like may be used. In addition, a conventional resist composition such as a composition that contains a polymer including an acid-labile group, a radiation-sensitive acid generating agent and an organic solvent may be used as the composition for use in forming the prepattern 103. Specifically, for example, a commercially available chemical amplification resist composition is applied to the substrate 101 or the underlayer film 102 to provide a resist film. Next, an exposure is carried out by irradiating a desired region of the resist film with a radioactive ray through a mask having a specific pattern. Examples of the radioactive ray include: electromagnetic waves such as ultraviolet rays, far ultraviolet rays and X-rays; charged particle rays such as electron beams and α-rays; and the like. Of these, far ultraviolet rays are preferred, ArF excimer laser beams and KrF excimer lasers are more preferred, and ArF excimer laser beams are still more preferred. Also, the exposure may employ a liquid immersion medium. Subsequently, post exposure baking (PEB) may be carried out, followed by development using a developer solution such as an alkaline developer solution and an organic solvent, whereby a desired prepattern 103 can be formed. In the resulting prepattern 103, it is preferred that curing thereof is accelerated by irradiation with an ultraviolet ray of, for example, 254 nm, followed by a heating treatment at 100° C. to 200° C. for 1 min to for 30 min.

It is to be noted that the surface of the prepattern 103 may be subjected to a hydrophobilization treatment or a hydrophilization treatment. As a specific treatment method, a hydrogenation treatment including exposing to hydrogen plasma for a certain time period, and the like may be exemplified. An increase of the hydrophobicity or hydrophilicity of the surface of the prepattern 103 enables the directed self-assembly in the coating film 104 to be further accelerated.

### Coating Film-Providing Step

In this step, a coating film in which the polymer (B) is unevenly distributed to be localized into a superficial layer region is provided using the directed self-assembling composition (I). The directed self-assembling composition (I) will be described later. In a case where the coating film is provided in a region compartmentalized by the prepattern 103 on the underlayer film 102, a coating film 104 is provided, and the polymer (B) is unevenly distributed to be localized into a superficial layer region 104b of the coating film, as shown in FIG. 3. Even in a case where the underlayer film and/or the prepattern are/is not used, the coating film can be provided. Since the polymer (B) contained in the directed self-assembling composition (I) has a lower surface free energy than that of the block copolymer (A), the polymer (B) is unevenly distributed to be localized into the superficial layer region 104b of the coating film 104 in the process of the formation of the coating film 104 using the directed self-assembling composition (I). In other words, the coating film 104 is constitution with the superficial layer region 104b containing the polymer (B) as a principal component, and a region 104a which is other than the superficial layer region 104b and contains the block copolymer (A) as a principal component.

The coating film 104 is typically provided by applying the directed self-assembling composition (I). Although the application method is not particularly limited, examples thereof include a spin coating procedure. In a case where the underlayer film 102 and the prepattern 103 are used, the region compartmentalized by the prepattern 103 on the underlayer film 102 is filled with the directed self-assembling composition (I), whereby the coating film 104 is provided.

When a compound having a relative permittivity of no less than 20 and no greater than 75, and a boiling point of no less than 180° C. and no greater than 300° C. at 1 atm as described later, is contained in the solvent contained in the directed self-assembling composition (I), the uneven distribution of the polymer (B) described above can be accelerated, whereby the microfabrication of a pattern obtained by the pattern-forming method may be further enhanced, or the amount of the polymer (B) used may be reduced.

### Directed Self-Assembling Step

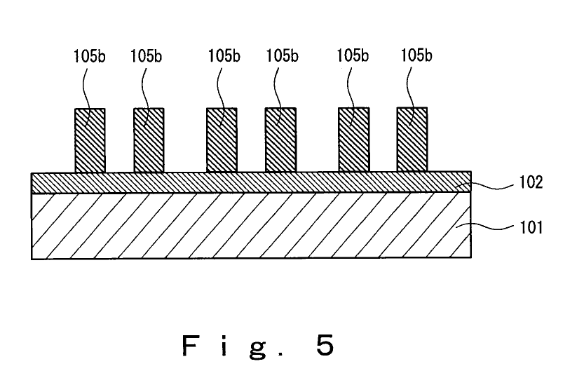

In this step, at least a part of the coating film provided in the coating film-providing step is converted into a directed self-assembling film by causing phase separation in the coating film along a substantially perpendicular direction. In the directed self-assembling step, for example, phase separation occurs along a substantially perpendicular direction in the region 104a other than the superficial layer region shown in FIG. 3, which is a part of the coating film 104 to form a directed self-assembling film 105 having phases 105a constituted with blocks (II) of the block copolymer (A) and phases 105b constituted with blocks (I), as shown in FIG. 4. In this instance, the directed self-assembling film 105 formed is constituted with the block copolymer (A). More specifically, blocks having identical properties are assembled with one another to spontaneously form an ordered pattern to cause phase separation along a substantially perpendicular direction, whereby the directed self-assembling film 105 is formed. In the course of the directed self-assembling step, the region 104a in which the directed self-assembly takes place, other than the superficial layer region is adjacent to the superficial layer region 104b, and the phase separation may easily occur in the formation of the directed self-assembling film 105 due to an interaction of the polymer (B) constituting the superficial layer region 104b with the block copolymer (A) constituting the region 104a other than the superficial layer region. Consequently, the directed self-assembling film 105 accompanied by favorable phase separation is formed. Although not necessarily clarified, the reason for achieving favorable phase separation described above is presumed as in the following, for example. In the case of not applying the polymer (B), phase separation tends to be accelerated in a substantially horizontal direction due to a large difference in terms of surface free energy between ambient air and the block copolymer (A). On the other hand, in the case of applying the polymer (B), the polymer (B) is unevenly distributed to be localized into the superficial layer region of the coating film of the directed self-assembling composition (I), leading to a decrease of the difference in terms of surface free energy between ambient air and the block copolymer (A). Thus, the phase separation in the substantially horizontal direction is inhibited, and consequently a phase separation effectively occurs along a substantially perpendicular direction.

Examples of the procedure for converting the coating film into a directed self-assembling film through phase separation include annealing, and the like.

The annealing process may include, for example, heating at a temperature of typically 80° C. to 400° C., more preferably 100° C. to 350° C., and still more preferably 150° C. to 300° C. in an oven, on a hot plate, etc., and the like. The annealing time period is typically 1 min to 120 min, preferably 2 min to 90 min, and more preferably 3 min to 60 min. The film thickness of the directed self-assembling film 105 thus obtained is preferably 0.1 nm to 500 nm, more preferably 0.5 nm to 100 nm, and still more preferably 1 nm to 60 nm.

When the prepattern 103 described above is employed, the phase separation structure is preferably formed along the prepattern, and the phase boundaries formed by the phase separation are more preferably substantially parallel to a lateral face of the prepattern. For example, in a block copolymer (A) constituted with a polystyrene block and a poly(meth)acrylic acid ester block, in a case where the prepattern 103 has a higher affinity to the polystyrene block of the block copolymer (A), a phase (105b) of the polystyrene block is linearly formed along the prepattern 103, and adjacent to the phase (105b), a phase (105a) of the poly(meth)acrylic acid ester block and the phase (105b) of the polystyrene block are alternately arranged in this order to form a lamellar phase separation structure, or the like. It is to be noted that the phase separation structure formed in this step is constituted with a plurality of phases, and typically the phase boundaries formed by these phases are substantially perpendicular to the substrate; however, the phase boundaries per se may not necessarily be clear. In addition, the resultant phase separation structure can be strictly controlled by way of a ratio of the length of each block (polystyrene block, poly(meth)acrylic acid ester block, etc.) in molecules of the block copolymer (A), the length of the molecule of the block copolymer (A) (weight average molecular weight, etc.), the underlayer film, the prepattern and the like, and thus, a directed self-assembling film having a phase separation structure such as a sea-island structure, a cylinder structure, a co-interconnected or a lamellar structure can be formed; consequently, a desired fine pattern can be obtained.

In the pattern-forming method, a further finer pattern can also be obtained by not only providing the superficial layer region 104b described above, contrary to the region 104a in which the directed self-assembly takes place, other than the superficial layer region so as to exhibit an interaction therebetween, but also forming the underlayer film 102 and/or the prepattern 103 described above such that an interaction thereof also has an effect on the directed self-assembly.

### Removing Step

In this step, a part of a plurality of phases of the directed self-assembling film are removed.

According to this step, for example, a part of a plurality of block phases 105a of the phase separation structure included in the directed self-assembling film 105 are removed, as shown in FIGS. 4 and 5. Thus, a part of the plurality of phases 105a can be removed through an etching treatment by utilizing, for example, the difference of an etching rate of each phase separated through the directed self-assembly. The superficial layer region 104b and/or the prepattern 103 each not included in the directed self-assembling film 105 can be also removed concurrently with or separately from the part of the plurality of phases. A state after removing a part of the plurality of phases 105a of the phase separation structure, the superficial layer region 104b and the prepattern 103 as described later, is shown in FIG. 5. It is to be noted that prior to the etching treatment, irradiation with a radioactive ray may be conducted as needed. As the radioactive ray, in a case where the phases to be removed by etching are phases of the polymethyl methacrylate block, a radioactive ray of 254 nm may be used. The irradiation with the radioactive ray results in decomposition of the phases of the polymethyl methacrylate block, whereby the etching can be facilitated.

As the procedure for removing a part of the plurality of phases of the phase separation structure included in the directed self-assembling film 105, well-known procedures e.g., reactive ion etching (RIE) such as chemical dry etching and chemical wet etching; physical etching such as sputter etching and ion beam etching; and the like may be exemplified. Of these, reactive ion etching (RIE) is preferred, and in particular, chemical dry etching carried out by using a CF₄ gas, an O₂ gas or the like, and chemical wet etching (wet development) carried out by using an etching liquid, i.e., an organic solvent, or a liquid such as hydrofluoric acid are more preferred. Examples of the organic solvent include: alkanes such as n-pentane, n-hexane and n-heptane; cycloalkanes such as cyclohexane, cycloheptane and cyclooctane; saturated carboxylic acid esters such as ethyl acetate, n-butyl acetate, i-butyl acetate and methyl propionate; ketones such as acetone, methyl ethyl ketone, methyl isobutyl ketone and methyl n-pentyl ketone; alcohols such as methanol, ethanol, 1-propanol, 2-propanol and 4-methyl-2-pentanol; and the like. It is to be noted that these solvents may be used either alone, or two or more types thereof may be used in combination.

### Prepattern-Removing Step

In this step, the prepattern 103 is removed, as shown in FIGS. 4 and 5. Removal of the prepattern 103 enables a finer and complicated pattern to be formed. It is to be noted that with respect to the procedure for removing the prepattern 103, the procedure described in connection with the procedure for removing a part of the plurality of phases of the phase separation structure may be employed. Also, this step may be carried out concomitantly with the removing step, or may be carried out before or after the removing step.

### Substrate Pattern-Forming Step

The pattern-forming method preferably further includes the substrate pattern-forming step after the removing step. In this step, using a pattern constituted with a residual part of the plurality of phases 105b of the directed self-assembling film as a mask, the silicon atom-containing film and the substrate are etched to permit patterning. After completion of the patterning onto the substrate, the phases used as a mask are removed from the substrate by a dissolving treatment or the like, whereby a patterned substrate (pattern) can be finally obtained. Examples of the resultant pattern include line-and-space patterns, hole patterns, and the like. As the procedure for the etching, a procedure similar to that in the removing step may be employed, and the etching gas and the etching liquid may be appropriately selected in accordance with the materials of the silicon atom-containing film and the substrate. For example, in a case where the substrate is a silicon material, a gas mixture of chlorofluorocarbon-containing gas and SF₄, or the like may be used. Alternatively, in a case where the substrate is a metal film, a gas mixture of BCl₃ and Cl₂, or the like may be used. The pattern obtained according to the pattern-forming method is suitably used for semiconductor elements and the like, and further the semiconductor elements are widely used for LED, solar cells, and the like.

### Directed Self-Assembling Composition (I)

The directed self-assembling composition (I) contains the block copolymer (A) and the polymer (B). The directed self-assembling composition (I) preferably contains (C) a solvent, and may contain other component, within a range not leading to impairment of the effects of the present invention.

Hereinafter, each component will be explained.

### (A) Block Copolymer

The block copolymer (A) has a structure in which a plurality of blocks are linked. Each of the blocks is constituted with a chain structure of structural units derived from a single type of monomer. According to the block copolymer (A) having such a plurality of blocks, the same type of blocks are aggregated by means of heating or the like, and phases each constituted with the same type of blocks are formed. In this process, it is presumed that since it is unlikely for phases each formed from a different type of blocks to mix with each other, a phase separation structure having an ordered pattern can be formed in which different types of phases are periodically and alternately repeated.

The block copolymer (A) is exemplified by a diblock copolymer, a triblock copolymer, a tetrablock copolymer, and the like. Of these, a diblock copolymer and a triblock copolymer are preferred, and a diblock copolymer is more preferred in light of the possibility of further facilitated formation of a pattern having desired fine microdomains.

The block is exemplified by a polystyrene block, a poly(meth)acrylic acid ester block, a polyvinyl acetal block, a polyurethane block, a polyurea block, a polyimide block, a polyamide block, an epoxy block, a novolak-type phenol block, a polyester block, and the like.

The block copolymer (A) is preferably constituted with a polystyrene block and a poly(meth)acrylic acid ester block in light of the possibility of facilitated formation of the phase separation structure and an ease of the removal of the phases.

In a case where the block copolymer (A) is a diblock copolymer, the molar ratio ((I)/(II)) of two structural units (I) and (II) constituting the diblock copolymer may be appropriately selected in accordance with a line/space width ratio of a desired line-spaces pattern, dimensions of a contact hole, and the like. However, in light of the possibility of formation of a finer and more favorable pattern, the molar ratio ((I)/(II)) of two structural units (I) and (II) is preferably no less than 35/65 and no greater than 65/35, and more preferably no less than 40/60 and no greater than 60/40 in the case of the formation of a line-and-space pattern. Alternatively, in the case of the formation of a contact hole pattern, the molar ratio ((I)/(II)) of two structural units (I) and (II) is preferably no less than 65/35 and no greater than 85/15, and more preferably no less than 65/35 and no greater than 75/25.

### Synthesis of Block Copolymer (A)

The block copolymer (A) can be synthesized by forming each block in a desired order through living anionic polymerization, living radical polymerization, or the like. For example, the block copolymer (A) can be synthesized by linking a polystyrene block, a poly(meth)acrylic acid ester block, other block that is distinct from these blocks, and the like through polymerization in a desired order, followed by the addition of methanol or the like to stop the polymerization.

For example, in a case where the block copolymer (A) which is a diblock copolymer constituted with the polystyrene block and the poly(meth)acrylic acid ester block is synthesized, styrene is first polymerized in an appropriate solvent using an anionic polymerization initiator to form the polystyrene block. Next, (meth)acrylic acid ester is similarly polymerized to form the poly(meth)acrylic acid ester block so as to connect to the polystyrene block. Thereafter, methanol or the like is added to stop the polymerization. It is to be noted that each block may be synthesized, for example, by a method involving adding a solution containing a monomer dropwise to a reaction solvent containing an initiator and allowing the polymerization reaction to proceed.

Examples of the solvent which may be used in the polymerization include:

alkanes such as n-pentane, n-hexane, n-heptane, n-octane, n-nonane and n-decane;

cycloalkanes such as cyclohexane, cycloheptane, cyclooctane, decalin and norbornane;

aromatic hydrocarbons such as benzene, toluene, xylene, ethylbenzene and cumene;

halogenated hydrocarbons such as chlorobutanes, bromohexanes, dichloroethanes, hexamethylene dibromide and chlorobenzene;

saturated carboxylic acid esters such as ethyl acetate, n-butyl acetate, i-butyl acetate and methyl propionate;

ketones such as acetone, 2-butanone, 4-methyl-2-pentanone and 2-heptanone;

ethers such as tetrahydrofuran, diethoxyethanes and diethoxyethanes;

alcohols such as methanol, ethanol, 1-propanol, 2-propanol and 4-methyl-2-pentanol; and the like. These solvents may be used either alone, or two or more types thereof may be used in combination.

Although the reaction temperature in the polymerization may be appropriately selected in accordance with the type of the initiator, the reaction temperature is typically −150° C. to 50° C., and preferably −80° C. to 40° C. The reaction time period is typically 5 min to 24 hrs, and preferably 20 min to 12 hrs.

The initiator which may be used in the polymerization is exemplified by an alkyllithium, an alkylmagnesium halide, naphthalene sodium, an alkylated lanthanoid compound, and the like. Of these, in the case where the polymerization is executed using styrene or methyl methacrylate as a monomer, the alkyllithium compound is preferably used.

In the polymerization, after each block is formed in a desired order as described above, the polymerization end may be treated with, for example, a hetero atom-containing end-capping agent to introduce a hetero atom-containing group into an end of the block copolymer (A). In a case where the hetero atom-containing group is introduced into an end of the block copolymer (A), phase separation in the directed self-assembling composition (I) may be more favorably controlled.

Examples of the hetero atom-containing end-capping agent include:

epoxy compounds such as 1,2-butylene oxide, butyl glycidyl ether, 2-ethylhexyl glycidyl ether, propylene oxide, ethylene oxide and epoxyamine;

nitrogen-containing compounds such as isocyanate compounds, thioisocyanate compounds, imidazolidinone, imidazole, aminoketones, pyrrolidone, diethylaminobenzophenone, nitrile compounds, aziridine, formamide, epoxyamine, benzylamine, oxime compounds, azine, hydrazone, imine, azocarboxylic acid esters, aminostyrene, vinylpyridine, aminoacrylate, aminodiphenylethylene and imide compounds;

silane compounds such as alkoxysilanes, aminosilanes, ketoiminosilanes, isocyanatosilanes, siloxanes, glycidylsilanes, mercaptosilanes, vinylsilanes, epoxysilanes, pyridylsilanes, piperazylsilanes, pyrrolidone silanes, cyanosilanes, and isocyanic acid silanes;

tin halides, silicon halides, and carbon dioxide; and the like.

The block copolymer (A) synthesized in the polymerization is preferably recovered through a reprecipitation procedure. More specifically, after completion of the polymerization reaction, the intended copolymer is recovered in the form of a powder through charging the reaction liquid into a reprecipitation solvent. As the reprecipitation solvent, alcohols, alkanes and the like may be used either alone or as a mixture of two or more types thereof. As alternatives to the reprecipitation procedure, a liquid separating operation, a column operation, an ultrafiltration operation or the like also enables the polymer to be recovered through eliminating low molecular components such as monomers and oligomers.

The weight average molecular weight (Mw) of the block copolymer (A) as determined by gel permeation (GPC) is preferably 1,000 to 150,000, more preferably 5,000 to 100,000, still more preferably 10,000 to 70,000, and particularly preferably 20,000 to 50,000. When the Mw of the block copolymer (A) falls within the above range, a pattern having a finer microdomain structure can be formed.

The ratio (Mw/Mn) of the Mw to the number average molecular weight (Mn) of the block copolymer (A) is typically 1 to 5, preferably 1 to 3, more preferably 1 to 2, still more preferably 1 to 1.5, and particularly preferably 1 to 1.2. When the Mw/Mn of the block copolymer (A) falls within the above range, a pattern having a finer microdomain structure can be formed.

The Mw and the Mn are determined by gel permeation chromatography (GPC) using GPC columns (“G2000HXL”×2, “G3000HXL”×1, and “G4000HXL”×1; available from Tosoh Corporation), a differential refractometer as a detector, and mono-dispersed polystyrene as a standard, under the analytical condition involving: an eluent of tetrahydrofuran (available from Wako Pure Chemical Industries, Ltd.); a flow rate of 1.0 mL/min; a sample concentration of 1.0% by mass; an amount of the sample injected of 100 μL; and a column temperature of 40° C.

### (B) Polymer

The polymer (B) has a lower surface free energy than that of the block copolymer (A). When a coating film is provided using the directed self-assembling composition (I), the polymer (B) is unevenly distributed to be localized into a superficial layer region of the coating film due to the polymer (B) having a lower surface free energy than that of the block copolymer (A).

The surface free energy of each polymer can be determined by, for example, providing a thin film of each polymer through spin coating of a solution of each polymer, followed by heating or the like, measuring a contact angle of a liquid such as pure water and methylene iodide on the thin film in accordance with a method of D. K. OWENS et al. described in a document “JOURNAL OF APPLIED POLYMER SCIENCE, VOL., 13, PP. 1741-1747 (1969)”, and calculating the surface free energy from the measured value using relationships shown in the following formulae (A) and (B):

(1+cos θ)×γ_{L}=2(γ_{S}^{d}×γ_{L}^{d})^{1/2}+2(γ_{S}^{p}×γ_{L}^{p})^{1/2} (A)

γ_{S}=γ_{S}^{d}+γ_{S}^{p} (B),

wherein γ_{S} represents the surface free energy of the polymer; γ_{S}^{d} represents a dispersive component of the surface free energy of the polymer; γ_{S}^{p} represents a polar component of the surface free energy of the polymer; γ_{L} represents the surface free energy of the liquid; γ_{L}^{d} represents a dispersive component of the surface free energy of the liquid; γ_{L}^{p} represents a polar component of the surface free energy of the liquid; and θ represents the contact angle.

The range of the value obtained by subtracting the surface free energy of the polymer (B) from the surface free energy of the block copolymer (A) is preferably 1 mN/m to 20 mN/m, more preferably 3 mN/m to 18 mN/m, still more preferably 5 mN/m to 15 mN/m, particularly preferably 7 mN/m to 13 mN/m, and more particularly preferably 9 mN/m to 11 mN/m. It is believed that when the difference of the surface free energy falls within the above range, the polymer (B) can be unevenly distributed more effectively in the coating film-providing step, and an interaction of the polymer (B) with the polymer (A) can be enhanced more effectively in the directed self-assembling step, and consequently a finer and more favorable pattern can be obtained.

Although the polymer (B) is not particularly limited as long as the polymer (B) has a lower surface free energy than that of the block copolymer (A), the polymer (B) preferably includes at least one selected from the group consisting of a fluorine atom and a silicon atom.

The polymer (B) preferably has a structural unit that includes at least one selected from the group consisting of a fluorine atom and a silicon atom (hereinafter, may be also referred to as “structural unit (I)”). The structural unit (I) that includes a fluorine atom is exemplified by a structural unit represented by the following formula (1) (hereinafter, may be also referred to as “structural unit (I-1)”), and the like.

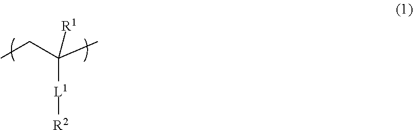

In the above formula (1), R¹ represents a hydrogen atom, a fluorine atom, an alkyl group having 1 to 4 carbon atoms, or a fluorinated alkyl group having 1 to 4 carbon atoms; L¹ represents a single bond, —O—, —COO—, —CONH—, —Ar¹—, —O—Ar¹—, —COO—Ar¹— or —CONH—Ar¹—; Ar¹ represents an arenediyl group having 6 to 20 carbon atoms; and R² represents a monovalent fluorinated hydrocarbon group having 1 to 20 carbon atoms.

The structural unit (I) that includes a silicon atom is exemplified by a structural unit represented by the following formula (2) (hereinafter, may be also referred to as “structural unit (I-2)”), and the like.

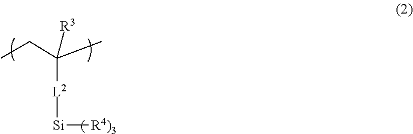

In the above formula (2), R³ represents a hydrogen atom, a fluorine atom, an alkyl group having 1 to 4 carbon atoms or a fluorinated alkyl group having 1 to 4 carbon atoms; L² represents a single bond, —O—, —COO—, —CONH—, —Ar²—, —O—Ar²—, —COO—Ar²— or —CONH—Ar²—; Ar² represents an arenediyl group having 6 to 20 carbon atoms; and R⁴ represents a hydrogen atom or an alkyl group having 1 to 10 carbon atoms, wherein the three R⁴s are identical or different.

Examples of the alkyl group having 1 to 4 carbon atoms which may be represented by R′ and R³ include a methyl group, an ethyl group, a n-propyl group, an i-propyl group, a n-butyl group, an i-butyl group, a sec-butyl group, a t-butyl, and the like.

Examples of the fluorinated alkyl group having 1 to 4 carbon atoms which may be represented by R′ and R³ include a fluoromethyl group, a difluoromethyl group, a trifluoromethyl group, a fluoroethyl group, a difluoroethyl group, a trifluoroethyl group, a pentafluoroethyl group, a heptafluoropropyl group, a nonafluorobutyl group, and the like.

Examples of the arenediyl group having 6 to 20 carbon atoms represented by Ar¹ and Ar² include a benzenediyl group, a toluenediyl group, a xylenediyl group, a naphthalenediyl group, an anthracenediyl group, and the like.

The monovalent fluorinated hydrocarbon group having 1 to 20 carbon atoms represented by R² is exemplified by:

fluorinated chain hydrocarbon groups including for example,

fluorinated alkyl groups such as a fluoromethyl group, a difluoromethyl group, a trifluoromethyl group, a trifluoroethyl group, a pentafluoroethyl group, a pentafluoro-n-propyl group, a hexafluoro-i-propyl group, a heptafluoro-n-butyl group and a nonafluoro-n-butyl group;

fluorinated alkenyl groups such as a fluoroethenyl group, a difluoroethenyl group, a trifluoroethenyl group and a trifluoropropenyl group; and

fluorinated alkynyl groups such as a fluoroethynyl group, a fluoropropenyl group, a trifluoropropenyl group and a trifluorobutynyl group,

fluorinated alicyclic hydrocarbon groups including for example,

fluorinated cycloalkyl groups such as a fluorocyclopropyl group, a fluorocyclopentyl group, an octafluorocyclopentyl group, a decafluorocyclohexyl group and a tetrafluoronorbornyl; and

fluorinated cycloalkenyl groups such as a fluorocyclopentenyl group, a hexafluorocyclopentenyl group, an octafluorocyclohexyl group and a difluoronorbornyl group; and

fluorinated aromatic hydrocarbon groups including for example,

fluorinated aryl groups such as a fluorophenyl group, a trifluorophenyl group, a pentafluorophenyl group, a fluorotolyl group, a hexafluoroxylyl group and a fluoronaphthyl group; and

fluorinated aralkyl groups such as a fluorobenzyl group, a difluorobenzyl group, a pentafluorobenzyl group and a pentafluorophenethyl group; and the like.

Examples of the alkyl group having 1 to 10 carbon atoms which may be represented by R⁴ include a methyl group, an ethyl group, a n-propyl group, an i-propyl group, a n-butyl group, a n-pentyl group, a n-hexyl group, a n-octyl group, a n-decyl group, and the like.

Examples of the structural unit (I-1) include structural units represented by the following formulae, and the like.

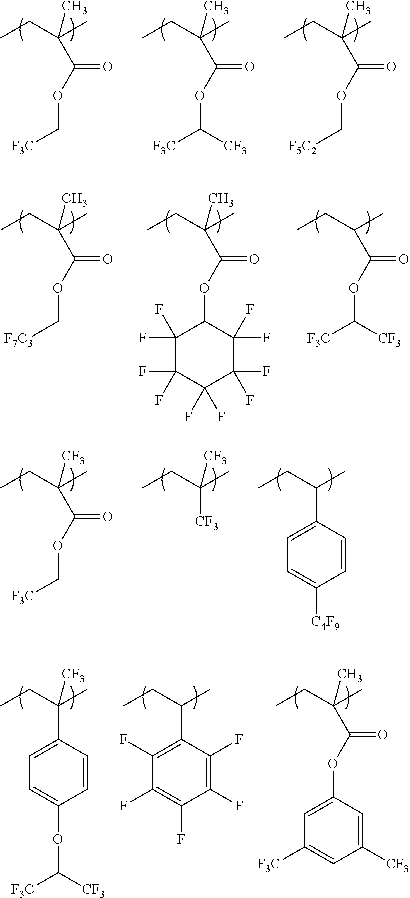

Examples of the structural unit (I-2) include structural units represented by the following formulae, and the like.

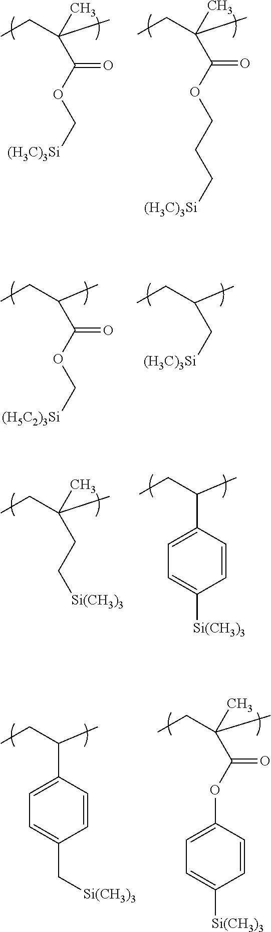

The lower limit of the proportion of the structural unit (I) with respect to the total structural units constituting the polymer (B) is preferably 10 mol %, more preferably 14 mol %, still more preferably 18 mol %, and particularly preferably 22 mol %. The upper limit of the proportion of the structural unit (I) is preferably 50 mol %, more preferably 45 mol %, still more preferably 40 mol %, and particularly preferably 36 mol %. When the proportion of the structural unit (I) falls within the above range, the uneven distribution of the polymer (B) described above and the interaction of the polymer (B) with the block copolymer (A) can be enhanced more effectively.

In addition, the polymer (B) may include a structural unit other than the structural unit (I) (hereinafter, may be also referred to as “structural unit (II)”). The structural unit (II) is exemplified by a structural unit derived from a (meth)acrylic acid ester, a structural unit derived from a styrene compound, and the like.

Examples of the (meth)acrylic acid ester include methyl(meth)acrylate, ethyl(meth)acrylate, butyl(meth)acrylate, cyclohexyl(meth)acrylate, norbornyl(meth)acrylate, adamantyl(meth)acrylate, tetrahydrofurfuryl(meth)acrylate, and the like.

Examples of the styrene compound include styrene, 2-methylstyrene, 3-methylstyrene, 4-methylstyrene, α-methylstyrene, 4-hydroxystyrene, 4-(t-butoxy)styrene, and the like.

The polymer (B) preferably includes at least a part of the types of the structural units included in the block copolymer (A) and more preferably includes all types of the structural units included in the block copolymer (A), since such constitutions are believed to enhance the interaction of the polymer (B) with the block copolymer (A) more adequately, and enable the phase separation structure formed by the directed self-assembly to be more favorably formed. For example, in a case where the block copolymer (A) is a diblock copolymer having a polystyrene block and a polytetrahydrofurfuryl(meth)acrylate block, the polymer (B) includes, in addition to the structural unit (I), preferably at least one of a structural unit derived from styrene and a structural unit derived from tetrahydrofurfuryl(meth)acrylate, and more preferably both of the structural unit derived from styrene and the structural unit derived from tetrahydrofurfuryl(meth)acrylate.

The polymer (B) is preferably a random copolymer in light of a more effectively achievable interaction of the polymer (B) with the block copolymer (A), leading to the formation of a more favorable phase separation structure.

### Synthesis Method of Polymer (B)

The polymer (B) can be synthesized, for example, by polymerizing monomers that give the structural units such as the structural unit (I) and the structural unit (II) in an appropriate solvent using a radical polymerization initiator or the like.

The radical polymerization initiator is exemplified by: azo radical initiators such as azobisisobutyronitrile (AIBN), 2,2′-azobis(4-methoxy-2,4-dimethylvaleronitrile), 2,2′-azobis(2-cyclopropylpropionitrile), 2,2′-azobis(2,4-dimethylvaleronitrile) and dimethyl 2,2′-azobisisobutyrate; peroxide radical initiators such as benzoyl peroxide, t-butyl hydroperoxide and cumene hydroperoxide; and the like. Of these, AIBN and dimethyl 2,2′-azobisisobutyrate are preferred, and AIBN is more preferred. These radical polymerization initiators may be used either alone, or as a mixture of two or more types thereof.

Examples of the solvent which may be used in the polymerization include solvents similar to those exemplified as the solvent for polymerization in connection with the synthesis method of the block copolymer (A) described above.

The reaction temperature in the polymerization is typically 40° C. to 150° C., and preferably 50° C. to 120° C. The reaction time period is typically 1 hour to 48 hrs, and preferably 1 hour to 24 hrs.

The Mw of the polymer (B) is preferably 1,000 to 100,000, more preferably 5,000 to 60,000, still more preferably 8,000 to 40,000, and particularly preferably 10,000 to 30,000. When the Mw of the polymer (B) falls within the above range, a pattern having a finer microdomain structure can be formed.

The ratio (Mw/Mn) of the Mw to the number average molecular weight (Mn) of the polymer (B) is typically 1 to 5, preferably 1 to 3, more preferably 1 to 2.5, still more preferably 1.1 to 1.8, and particularly preferably 1.1 to 1.5. When the Mw/Mn of the polymer (B) falls within the above range, a pattern having a finer microdomain structure can be formed.

### (C) Solvent

The directed self-assembling composition (I) typically contains the solvent (C). The solvent (C) is not particularly limited as long as it can at least dissolve or disperse the block copolymer (A) and the polymer (B).

The solvent (C) is exemplified by an alcohol solvent, an ether solvent, a ketone solvent, an amide solvent, an ester solvent, a hydrocarbon solvent, and the like.

Examples of the alcohol solvent include:

monohydric alcohol solvents such as methanol, ethanol, n-propanol, iso-propanol, n-butanol, iso-butanol, sec-butanol, tert-butanol, n-pentanol, iso-pentanol, 2-methylbutanol, sec-pentanol, tert-pentanol, 3-methoxybutanol, n-hexanol, 2-methylpentanol, sec-hexanol, 2-ethylbutanol, sec-heptanol, 3-heptanol, n-octanol, 2-ethylhexanol, sec-octanol, n-nonyl alcohol, 2,6-dimethyl-4-heptanol, n-decanol, sec-undecyl alcohol, trimethylnonyl alcohol, sec-tetradecyl alcohol, sec-heptadecyl alcohol, furfuryl alcohol, phenol, cyclohexanol, methylcyclohexanol, 3,3,5-trimethylcyclohexanol, benzyl alcohol and diacetone alcohol;

polyhydric alcohol solvents such as ethylene glycol, 1,2-propylene glycol, 1,3-butylene glycol, 2,4-pentanediol, 2-methyl-2,4-pentanediol, 2,5-hexanediol, 2,4-heptanediol, 2-ethyl-1,3-hexanediol, diethylene glycol, dipropylene glycol, triethylene glycol and tripropylene glycol;

polyhydric alcohol partial ether solvents such as ethylene glycol monomethyl ether, ethylene glycol monoethyl ether, ethylene glycol monopropyl ether, ethylene glycol monobutyl ether, ethylene glycol monohexyl ether, ethylene glycol monophenyl ether, ethylene glycol mono-2-ethylbutyl ether, diethylene glycol monomethyl ether, diethylene glycol monoethyl ether, diethylene glycol monopropyl ether, diethylene glycol monobutyl ether, diethylene glycol monohexyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether and dipropylene glycol monopropyl ether; and the like.

Examples of the ether solvent include:

dialkyl ether solvents such as diethyl ether, dipropyl ether and dibutyl ether;

cyclic ether solvents such as tetrahydrofuran and tetrahydropyran;

aromatic ring-containing ether solvents such as diphenyl ether and anisole(methyl phenyl ether); and the like.

Examples of the ketone solvent include:

chain ketone solvents such as acetone, methyl ethyl ketone, methyl n-propyl ketone, methyl n-butyl ketone, diethyl ketone, methyl iso-butyl ketone, 2-heptanone(methyl n-pentyl ketone), ethyl n-butyl ketone, methyl n-hexyl ketone, di-iso-butyl ketone and trimethylnonanone:

cyclic ketone solvents such as cyclopentanone, cyclohexanone, cycloheptanone, cyclooctanone and methylcyclohexanone:

2,4-pentanedione, acetonylacetone, and acetophenone; and the like.

Examples of the amide solvent include:

cyclic amide solvents such as N,N′-dimethylimidazolidinone and N-methylpyrrolidone;

chain amide solvents such as N-methylformamide, N,N-dimethylformamide, N,N-diethylformamide, acetamide, N-methylacetamide, N,N-dimethylacetamide and N-methylpropionamide; and the like.

Examples of the ester solvent include:

acetic acid ester solvents such as methyl acetate, ethyl acetate, n-propyl acetate, iso-propyl acetate, n-butyl acetate, iso-butyl acetate, sec-butyl acetate, n-pentyl acetate, i-pentyl acetate, sec-pentyl acetate, 3-methoxybutyl acetate, methylpentyl acetate, 2-ethylbutyl acetate, 2-ethylhexyl acetate, benzyl acetate, cyclohexyl acetate, methylcyclohexyl acetate and n-nonyl acetate;

polyhydric alcohol partially etherated acetate solvents such as ethylene glycol monomethyl ether acetate, ethylene glycol monoethyl ether acetate, diethylene glycol monomethyl ether acetate, diethylene glycol monoethyl ether acetate, diethylene glycol mono-n-butyl ether acetate, propylene glycol monomethyl ether acetate, propylene glycol monoethyl ether acetate, propylene glycol monopropyl ether acetate, propylene glycol monobutyl ether acetate, dipropylene glycol monomethyl ether acetate and dipropylene glycol monoethyl ether acetate;

lactone solvents such as γ-butyrolactone and valerolactone;

carbonate solvents such as dimethyl carbonate, diethyl carbonate, ethylene carbonate and propylene carbonate;

glycol diacetate, methoxytriglycol acetate, ethyl propionate, n-butyl propionate, iso-amyl propionate, diethyl oxalate, di-n-butyl oxalate, methyl acetoacetate, ethyl acetoacetate, methyl lactate, ethyl lactate, n-butyl lactate, n-amyl lactate, diethyl malonate, dimethyl phthalate and diethyl phthalate; and the like.

Examples of the hydrocarbon solvent include:

aliphatic hydrocarbon solvents such as n-pentane, iso-pentane, n-hexane, iso-hexane, n-heptane, iso-heptane, 2,2,4-trimethylpentane, n-octane, iso-octane, cyclohexane and methylcyclohexane;

aromatic hydrocarbon solvents such as benzene, toluene, xylene, mesitylene, ethylbenzene, trimethylbenzene, methylethylbenzene, n-propylbenzene, iso-propylbenzene, diethylbenzene, iso-butylbenzene, triethylbenzene, di-iso-propylbenzene and n-amylnaphthalene; and the like.

Of these, an ester solvent and a ketone solvent are preferred, a polyhydric alcohol partially etherated acetate solvent and a cyclic ketone solvent are more preferred, and propylene glycol monomethyl ether acetate and cyclohexanone are still more preferred. The directed self-assembling composition (I) may contain one, or two or more types of the solvent (C).

Of these, a compound having a relative permittivity of no less than 20 and no greater than 75, and a boiling point of no less than 180° C. and no greater than 300° C. at 1 atm (hereinafter, may be also referred to as “compound (I)”) is preferably contained as the solvent (C).

The compound (I) exhibits the effects of more efficiently achieving the uneven distribution of the polymer (B) contained in the directed self-assembling composition (I) to be localized into the superficial layer region of the coating film. When the solvent (C) in the directed self-assembling composition (I) contains the compound (I), the resulting pattern can be finer and more favorable. In addition, the amount of the polymer (B) used can be reduced.

Examples of the compound (I) include:

lactone compounds such as γ-butyrolactone, valerolactone, mevalonic lactone and norbornanelactone;

carbonate compounds such as propylene carbonate, ethylene carbonate, butylene carbonate and vinylene carbonate;

nitrile compounds such as succinonitrile; and

polyhydric alcohols such as glycerin.

The content of the compound (I) with respect to 100 parts by mass of the total amount of the polymer in the directed self-assembling composition (I) is preferably 10 parts by mass to 500 parts by mass, more preferably 15 parts by mass to 300 parts by mass, still more preferably 20 parts by mass to 200 parts by mass, and particularly preferably 25 parts by mass to 100 parts by mass.

### Other Component

The directed self-assembling composition (I) may contain other component, in addition to the components (A) to (C). Examples of the other component include a surfactant and the like. When the directed self-assembling composition (I) contains the surfactant, application properties thereof to a substrate or the like can be improved.

### Preparation Method of Directed Self-Assembling Composition

The directed self-assembling composition (I) may be prepared, for example, by mixing the block copolymer (A) and the polymer (B) and the like with the solvent (C), preferably followed by filtration through a membrane filter having a pore size of about 200 nm. The solid content concentration of the directed self-assembling composition (I) is preferably 0.01% by mass to 50% by mass, more preferably 0.1% by mass to 20% by mass, still more preferably 0.2% by mass to 10% by mass, and particularly preferably 0.3% by mass to 5% by mass.

### Directed Self-Assembling Composition

A directed self-assembling composition according to another embodiment of the present invention contains a block copolymer, and a polymer having a lower surface free energy than that of the block copolymer.

Since the directed self-assembling composition has the constitution described above, a sufficiently fine pattern can be formed. The directed self-assembling composition has been described as the directed self-assembling composition (I) for use in the pattern-forming method according to the embodiment of the present invention.

### EXAMPLES

Hereinafter, the present invention is explained in detail by way of Examples, but the present invention is not in any way limited to these Examples. Measuring methods of physical properties are shown below.

### Mw and Mn

The Mw and the Mn of the polymer were determined by gel permeation chromatography (GPC) using GPC columns (Tosoh Corporation, “G2000HXL”×2, “G3000HXL”×1, “G4000HXL”×1) under the following condition:

eluent: tetrahydrofuran (Wako Pure Chemical Industries, Ltd.);

flow rate: 1.0 mL/min;

sample concentration: 1.0% by mass;

amount of sample injected: 100 μL;

column temperature: 40° C.;

detector: differential refractometer; and

standard substance: mono-dispersed polystyrene.

### ¹³C-NMR Analysis

¹³C-NMR analysis was carried out using a nuclear magnetic resonance apparatus (“JNM-EX400” available from JEOL, Ltd.) with DMSO-d₆ as a solvent for measurement. The proportion of each structural unit in the polymer was calculated from an area ratio of a peak corresponding to each repeating unit on the spectrum obtained by ¹³C-NMR.

### Surface Free Energy

A 2% by mass solution of each polymer (solvent: propylene glycol monomethyl ether acetate) was spin-coated on a silicon wafer, followed by heating at 100° C. for 1 min to provide a thin film having a film thickness of 40 nm. Then, a contact angle of a liquid such as pure water and methylene iodide on the thin film was measured in accordance with a method of D. K. OWENS et al. described in a document “JOURNAL OF APPLIED POLYMER SCIENCE, VOL., 13, PP. 1741-1747 (1969)”, and the surface free energy was calculated from the measured value using relationships shown in the following formulae (A) and (B):

(1+cos θ)×γ_{L}=2(γ_{S}^{d}×γ_{L}^{d})^{1/2}+2(γ_{S}^{p}×γ_{L}^{p})^{1/2} (A)

γ_{S}=γ_{S}^{d}+γ_{S}^{p} (B),

wherein γ_{S} represents the surface free energy of the polymer; γ_{S}^{d} represents a dispersive component of the surface free energy of the polymer; γ_{S}^{p} represents a polar component of the surface free energy of the polymer; γ_{L} represents the surface free energy of the liquid; γ_{L}^{d} represents a dispersive component of the surface free energy of the liquid; γ_{L}^{p} represents a polar component of the surface free energy of the liquid; and θ represents the contact angle.

### Synthesis of Polymer

Monomers used in the synthesis of the block copolymer (A) and the polymer (B) are shown below.

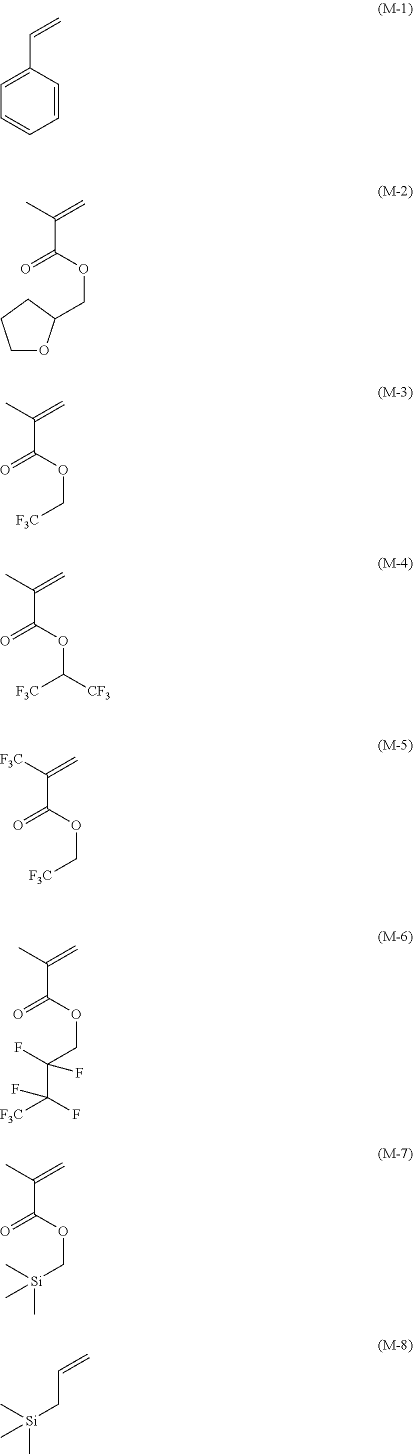

### Synthesis of Block Copolymer (A)

### Synthesis Example 1

Into a nitrogen-substituted reaction vessel having an inner volume of 0.5 L were charged 200 g of tetrahydrofuran. After 0.047 g of s-butyllithium as an initiator and 10 g of the compound (M-1) (styrene) were added, the polymerization was allowed to proceed at −70° C. to form a polystyrene block. After the completion of the polymerization was confirmed, 0.40 g of diphenylethylene and 0.063 g of lithium chloride were added. Further, 12 g of the compound (M-2) (tetrahydrofurfuryl methacrylate) was added to the reaction vessel, and the polymerization was allowed to proceed to form a poly(tetrahydrofurfuryl methacrylate) block. After the completion of the polymerization was confirmed, a certain amount of methanol was added to stop the polymerization, whereby a block copolymer (A-1) was synthesized. The progress of the polymerization was chased through determination of the residual solid content by the measurement after heating the polymerization reaction solution sampled into an aluminum plate on a hot plate at 150° C. The block copolymer (A-1) had an Mw of 36,800, and an Mw/Mn of 1.10. In addition, the result of the ¹³C-NMR analysis indicated that the proportions of the structural unit derived from (M-1) and the structural unit derived from (M-2) were 50 mol % and 50 mol %, respectively. The block copolymer (A-1) had a surface free energy of 41 mN/m.

### Synthesis Example 2

A block copolymer (A-2) was synthesized in a similar manner to Synthesis Example 1 except that the amount of the compound (M-2) was changed from 12 g to 5 g. The block copolymer (A-2) had an Mw of 36,800, and an Mw/Mn of 1.10. In addition, the result of the ¹³C-NMR analysis indicated that the proportions of the structural unit derived from (M-1) and the structural unit derived from (M-2) were 70 mol % and 30 mol %, respectively. The block copolymer (A-2) had a surface free energy of 41 mN/m.

### Synthesis of Polymer (B)

### Synthesis Example 3

A monomer solution was prepared by dissolving 24.90 g (35 mol %) of the compound (M-1), 40.66 g (35 mol %) of the compound (M-2) and 34.44 g (30 mol %) of the compound (M-3) in 200 g of 2-butanone, and further charging thereinto 1.12 g of AIBN as a radical polymerization initiator. A 1,000 mL three-neck flask into which 100 g of 2-butanone was charged was purged with nitrogen for 30 min. After the nitrogen-purging, the reaction vessel was heated to 80° C. with stirring, and then the monomer solution prepared above was added dropwise over 3 hrs using a dropping funnel. The time of the start of the dropwise addition was considered to be the time of start of the polymerization, and the polymerization reaction was allowed to proceed for 6 hrs. After completing the polymerization, the polymerization reaction solution was cooled to 30° C. or below by water-cooling. After cooling, the polymerization reaction solution was charged into 2,000 g of methanol, and a deposited white powder was filtered off. An operation of dispersing the filtered white powder in 400 g of methanol to form a slurry, washing, and filtering the white powder off was conducted twice. Thereafter, the white powder was dried in vacuo at 50° C. for 17 hrs to obtain a polymer (B-1) as a white powder. The polymer (B-1) had an Mw of 20,070, and an Mw/Mn of 1.28. In addition, the result of the ¹³C-NMR analysis indicated that the proportions of the structural unit derived from (M-1), the structural unit derived from (M-2) and the structural unit derived from (M-3) were 34.7 mol %, 34.4 mol % and 30.9 mol %, respectively. The polymer (B-1) had a surface free energy of 29 mN/m.

### Synthesis Examples 4 to 8

Polymers (B-2) to (B-6) were obtained in a similar manner to Synthesis Example 3 except that the type and the amount of the monomer used were as shown in Table 1 below. The total mass of the monomer used was 100 g. The proportions of the structural units, the Mw, the Mw/Mn and the surface free energy of the obtained polymer are shown together in Table 1.

TABLE 1

| | | Structural unit (I) | | | Structural unit (II-1) | | | Structural unit (II-2) | | | | | Surface |
|---|---|---|---|---|---|---|---|---|---|---|---|---|---|
| | | | | proportion | | | proportion | | | proportion | | | free |
| | (B) | | amount | of structural | | amount | of structural | | amount | of structural | | | energy |
| | Polymer | type | (mol %) | unit (mol %) | type | (mol %) | unit (mol %) | type | (mol %) | unit (mol %) | Mw | Mw/Mn | (mN/m) |
| Synthesis | B-1 | M-3 | 30 | 30.9 | M-1 | 35 | 34.7 | M-2 | 35 | 34.4 | 20,070 | 1.28 | 29 |
| Example 3 | | | | | | | | | | | | | |
| Synthesis | B-2 | M-4 | 15 | 15.7 | M-1 | 45 | 44.6 | M-2 | 40 | 39.7 | 20,420 | 1.26 | 34 |
| Example 4 | | | | | | | | | | | | | |
| Synthesis | B-3 | M-5 | 30 | 30.8 | M-1 | 40 | 39.6 | M-2 | 30 | 29.6 | 20,280 | 1.29 | 25 |
| Example 5 | | | | | | | | | | | | | |
| Synthesis | B-4 | M-6 | 20 | 20.5 | M-1 | 35 | 34.8 | M-2 | 45 | 44.7 | 20,490 | 1.27 | 32 |
| Example 6 | | | | | | | | | | | | | |
| Synthesis | B-5 | M-7 | 35 | 35.7 | M-1 | 35 | 34.7 | M-2 | 30 | 29.6 | 19,680 | 1.26 | 22 |
| Example 7 | | | | | | | | | | | | | |
| Synthesis | B-6 | M-8 | 15 | 15.2 | M-1 | 50 | 50.1 | M-2 | 35 | 34.7 | 20,830 | 1.25 | 31 |
| Example 8 | | | | | | | | | | | | | |

### Preparation of Directed Self-Assembling Composition

The solvents (C) used in the preparation of directed self-assembling compositions are shown below.

### (C) Solvent

C-1: propylene glycol monomethyl ether acetate

C-2: γ-butyrolactone (compound (I)), having a relative permittivity of 42 at 25° C., and a boiling point of 204° C. at 1 atm

### Example 1

A directed self-assembling composition (J-1) was prepared by mixing 100 parts by mass of (A-1) as the block copolymer (A), 10 parts by mass of (B-1) as the polymer (B), and 15,840 parts by mass of (C-1) and 50 parts by mass of (C-2) as the solvent (C), followed by filtration of the resulting mixture through a membrane filter having a pore size of 200 nm.

### Examples 2 to 12 and Comparative Examples 1 and 2

Directed self-assembling compositions (J-2) to (J-12) as well as (CJ-1) and (CJ-2) were prepared in a similar manner to Example 1 except that the type and the content of each component used were as shown in Tables 2 and 3 below.

### Formation of Pattern

### Formation of Line-and-Space Pattern

On a 12-inch silicon wafer was spin-coated a composition for forming an organic underlayer film containing a crosslinking agent using a spin coater (“CLEAN TRACK ACT12” available from Tokyo Electron Limited), followed by baking at 205° C. for 60 sec to provide an organic underlayer film having a film thickness of 77 nm. Next, after an ArF resist composition containing a polymer that includes an acid-labile group, a radiation-sensitive acid generating agent and an organic solvent was spin-coated on the organic underlayer film, prebaking (PB) was carried out at 120° C. for 60 sec to provide a resist film having a film thickness of 60 nm. Then, the resist film was exposed through a mask pattern using ArF Immersion Scanner (“NSR-S610C” available from NIKON Corporation), under an optical condition involving NA of 1.30, Dipole-x, and σ of 0.977/0.78. Thereafter, PEB was carried out at 115° C. for 60 sec, and then a development with a 2.38% by mass aqueous tetramethylammonium hydroxide solution was carried out at 23° C. for 30 sec, followed by washing with water and drying to give a line-and-space prepattern (line of 72 nm/pitch of 170 nm). Then, the prepattern was irradiated with an ultraviolet ray of 254 nm under the condition of 150 mJ/cm², followed by baking at 170° C. for 5 min to obtain a substrate having the underlayer film and the prepattern formed thereon.

Each directed self-assembling composition prepared in Examples 1 to 6 and Comparative Example 1 was applied to the substrate obtained above such that the formed coating film had a thickness of 30 nm. Thereafter, the directed self-assembling composition was heated at 250° C. for 5 min such that phase separation took place, whereby a microdomain structure was formed. Then, after irradiation with a radioactive ray of 172 nm at an intensity of 300 mJ/cm², immersion in a mixed liquid of methyl isobutyl ketone (MIBK)/2-propanol (IPA)=2/8 (mass ratio) for 5 min allowed the phases constituted with the poly(tetrahydrofurfuryl methacrylate) block to be removed through dissolution, whereby a line-and-space pattern was formed.

### Formation of Contact Hole Pattern

Contact hole patterns were formed in a similar manner to the procedure described in the above section “Formation of Line-and-Space Pattern” except that the resist film was exposed through a mask pattern under an optical condition involving NA of 1.30, CrossPole, and σ of 0.977/0.78, whereby a contact hole prepattern with holes having a diameter of 70 nm/pitch of 170 nm was obtained, and that the directed self-assembling compositions prepared in Examples 7 to 12 and Comparative Example 2 were used.

### Evaluation

Each line-and-space pattern and each contact hole pattern formed above was observed using a line-width measurement SEM (“CG5000” available from Hitachi, Ltd.), and a line width (width of the microdomain structure (nm)) of the microdomain structure formed between facing sides of the trench-type prepattern or contact hole-type prepattern was measured. The results of the evaluation are shown in Tables 2 and 3.

TABLE 2

| | | (A) Block | | | | | | |
|---|---|---|---|---|---|---|---|---|
| | Directed | copolymer | | (B) Polymer | | (C) Solvent | | |
| | self- | | content | | content | | content | Line width of |
| | assembling | | (parts by | | (parts by | | (parts by | microdomain |
| | composition | type | mass) | type | mass) | type | mass) | structure (nm) |
| Example 1 | J-1 | A-1 | 100 | B-1 | 10 | C-1/C-2 | 15,840/50 | 9.8 |
| Example 2 | J-2 | A-1 | 100 | B-2 | 5 | C-1/C-2 | 20,295/100 | 9.7 |
| Example 3 | J-3 | A-1 | 100 | B-3 | 3 | C-1/C-2 | 20,100/100 | 9.9 |
| Example 4 | J-4 | A-1 | 100 | B-4 | 5 | C-1/C-2 | 15,340/50 | 9.8 |
| Example 5 | J-5 | A-1 | 100 | B-5 | 10 | C-1/C-2 | 15,840/50 | 9.8 |
| Example 6 | J-6 | A-1 | 100 | B-6 | 5 | C-1/C-2 | 20,295/100 | 9.7 |
| Comparative | CJ-1 | A-1 | 100 | — | — | C-1/C-2 | 19,600/100 | pattern |
| Example 1 | | | | | | | | formation failed |

TABLE 3

| | | (A) Block | | | | | | |
|---|---|---|---|---|---|---|---|---|
| | Directed | copolymer | | (B) Polymer | | (C) Solvent | | |
| | self- | | amount | | amount | | amount | Line width of |
| | assembling | | (parts by | | (parts by | | (parts by | microdomain |
| | composition | type | mass) | type | mass) | type | mass) | structure (nm) |
| Example 7 | J-7 | A-2 | 100 | B-1 | 10 | C-1/C-2 | 15,840/50 | 13.6 |
| Example 8 | J-8 | A-2 | 100 | B-2 | 5 | C-1/C-2 | 20,295/100 | 13.8 |
| Example 9 | J-9 | A-2 | 100 | B-3 | 3 | C-1/C-2 | 20,100/100 | 13.5 |
| Example 10 | J-10 | A-2 | 100 | B-4 | 5 | C-1/C-2 | 15,340/50 | 13.7 |
| Example 11 | J-11 | A-2 | 100 | B-5 | 10 | C-1/C-2 | 15,840/50 | 13.6 |
| Example 12 | J-12 | A-2 | 100 | B-6 | 5 | C-1/C-2 | 20,295/100 | 13.8 |
| Comparative | CJ-2 | A-2 | 100 | — | — | C-1/C-2 | 19,600/100 | pattern |
| Example 2 | | | | | | | | formation failed |

As is seen from the results shown in Tables 2 and 3, the pattern-forming method according to Examples enables a line-and-space pattern and a contact hole pattern each having a sufficiently fine microdomain structure to be obtained conveniently. In contrast, in the pattern-forming method according to Comparative Examples, phase separation hardly occurs in the pattern formation, and therefore a microdomain structure is unlikely to be formed.

The pattern-forming method and the directed self-assembling composition according to the embodiments of the present invention enable a sufficiently fine pattern to be conveniently formed. Therefore, these can be suitably used for lithography processes in manufacture of various types of electronic devices such as semiconductor devices and liquid crystal devices for which further miniaturization is demanded.

Obviously, numerous modifications and variations of the present invention are possible in light of the above teachings. It is therefore to be understood that within the scope of the appended claims, the invention may be practiced otherwise than as specifically described herein.

What is claimed is:

1. A pattern-forming method comprising:
providing a coating film using a composition that comprises: a first polymer which is a block copolymer; and a second polymer having a surface free energy lower than a surface free energy of the first polymer, such that the second polymer is unevenly distributed to be localized into a superficial layer region of the coating film;
causing phase separation in the coating film along a direction substantially perpendicular to a thickness direction of the coating film such that at least a part of the coating film is converted into a directed self-assembling film which comprises a plurality of phases; and
removing a part of the plurality of phases of the directed self-assembling film.

2. The pattern-forming method according to claim 1, wherein the directed self-assembling film comprises the first polymer.

3. The pattern-forming method according to claim 1, wherein a value obtained by subtracting the surface free energy of the second polymer from the surface free energy of the first polymer is no less than 1 mN/m and no greater than 20 mN/m.

4. The pattern-forming method according to claim 1, wherein the second polymer comprises a fluorine atom or a silicon atom, or both thereof.

5. The pattern-forming method according to claim 1, wherein the second polymer comprises a structural unit which comprises a fluorine atom or a silicon atom, or both thereof, and an amount of the structural unit in the second polymer is no less than 10 mol % and no greater than 50 mol % based on 100 mol % of the second polymer.

6. The pattern-forming method according to claim 1, wherein the second polymer comprises all kinds of structural units comprised in the first polymer.

7. The pattern-forming method according to claim 1, wherein the composition further comprises a compound having a relative permittivity of no less than 20 and no greater than 75, and a boiling point of no less than 180° C. and no greater than 300° C. at 1 atm.

8. The pattern-forming method according to claim 1, further comprising:
providing an underlayer film on a substrate before providing the coating film,
wherein in providing the coating film, the coating film is provided on the underlayer film.

9. The pattern-forming method according to claim 1, further comprising:
forming a prepattern before providing the coating film,
wherein in providing the coating film, the coating film is provided in a region compartmentalized by the prepattern.

10. The pattern-forming method according to claim 1, wherein a line-and-space pattern or a hole pattern is formed by removing the part of the plurality of phases of the directed self-assembling film.

11. A directed self-assembling composition comprising:
a block copolymer; and
a polymer having a surface free energy lower than a surface free energy of the block copolymer.
